(19) United States
(12) Patent Application Publication
(10) Pub. No.: US 2023/0025111 A1
(43) Pub. Date: Jan. 26, 2023

(54) ENGINEERED CARBON AND METHOD FOR PREPARING SAME

(71) Applicants: SKC CO., LTD., Gyeonggi-do (KR); URBANMINER INC., Seoul (KR)

(72) Inventor: Yong Hun NA, Seoul (KR)

(21) Appl. No.: 17/787,359

(22) PCT Filed: Jan. 4, 2021
(86) PCT No.: PCT/KR2021/000011

§ 371 Date: Jun. 20, 2022

(30) Foreign Application Priority Data
Jan. 7, 2020 (KR) 10-2020-0002210
Jun. 17, 2020 (KR) 10-2020-0073449
Sep. 22, 2020 (KR) 10-2020-0122371
Sep. 22, 2020 (KR) 10-2020-0122372

(51) Int. Cl. A23F 5/02; A23L 33/10; A23F 5/04

(52) U.S. Cl. CPC A23F 5/02; A23L 33/10; A23F 5/04; A23V 2002/00

(57) ABSTRACT

The present invention provides an engineered carbon formed by carbonizing green coffee beans, coffee beans, and a combination thereof, and a method for preparing same. The engineered carbon may comprise essential nutrients required for humans, such as calcium, magnesium, potassium, sodium, phosphorus, manganese, and the like, and can realize excellent adsorption performance which is intrinsic to an engineered carbon, thus advantageously exhibiting variable applications for oral administration.

### TECHNICAL FIELD

The present invention relates to engineered carbon and to a process for preparing the same. Specifically, it relates to edible engineered carbon that is harmless to the human body and can be used as various health supplements and to a process for preparing the same.

### BACKGROUND ART

New renewable energy is classified into solar energy, biomass, wind power, small hydropower, fuel cell, coal liquefaction, gasification, marine energy, waste energy, and others, rather than fossil fuels such as coal, oil, nuclear power, and natural gas. It also refers to a fluid fuel mixed with materials from geothermal, hydrogen, and coal. Biomass among them, which is originally an ecological term, refers to an organic mass of living animals, plants, and microorganisms. Thus, in ecological terms, trunks, roots, and leaves of trees are representative biomass, whereas dead organic materials such as waste wood and livestock manure are not biomass. However, it is common in the industry to encompass such organic wastes in biomass. A bioenergy utilization technology, which is one of the new renewable energy sources, refers to a technology in the chemical, biological, and combustion engineering that uses biomass in the form of liquid, gas, solid fuel, electricity, or thermal energy directly or through biochemical and physical conversion processes. Various materials prepared by utilizing these new renewable energy technologies are spotlighted as next-generation materials for a wide range of uses in an environment where interest in environment-friendliness is increasing in recent years. In particular, one of the front-line industrial fields in which these new renewable energy technologies are utilized is a field closely related to the human body, such as food and medicine. In the industrial field that can directly or indirectly affect the human body, the need to be based on environment-friendly factors is very large as compared with other fields; thus, the appropriate application and utilization of these new renewable energy technologies are expanding.

Engineered carbon has excellent adsorption characteristics; thus, it can be applied to various fields such as orally administered adsorbents, medical adsorbents, water purification adsorbents, carriers, masks, carbon/polymer composites, adsorption sheets, and functional foods (see Patent Document 1). However, in the conventional method of producing engineered carbon, heavy metals such as arsenic and lead may be incorporated in the process, leading to the possibility that these components remain in the engineered carbon; and impurities remain depending on the type of raw materials used, such as petroleum-based raw materials, wood such as oak or pine, coconut shell, or bamboo. Thus, it is not suitable for consumption.

### PRIOR ART DOCUMENT

### Patent Document

(Patent Document 1) Korean Laid-open Patent Publication No. 10-2009-0074360

### DETAILED DESCRIPTION OF THE INVENTION

### Technical Problem

An object of the present invention is to provide engineered carbon that is edible, harmless to the human body, and capable of adsorbing harmful substances only without adsorbing substances beneficial to the human body.

### Solution to the Problem

According to an embodiment of the present invention, there is provided engineered carbon formed by carbonizing green coffee beans, whole coffee beans, or a combination thereof.

According to another embodiment of the present invention, there is provided a process for preparing engineered carbon, which comprises drying green coffee beans, whole coffee beans, or a combination thereof; and thermally treating the dried green coffee beans, whole coffee beans, or a combination thereof.

According to still another embodiment of the present invention, there is provided engineered food, which comprises the engineered carbon.

### Advantageous Effects of the Invention

The engineered carbon has an advantage in that it may have a structure that can be easily modified to have adsorption selectivity for a specific component, which is attributable to its appropriate pore structure; and that, upon modification, it can achieve excellent adsorption performance for a specific component and, at the same time, can be used for various applications in its overall size and shape.

The engineered carbon has an advantage in that it is harmless to the human body, can contain essential nutrients necessary for humans such as calcium, magnesium, potassium, sodium, phosphorus, and manganese, and can achieve excellent adsorption performance as engineered carbon, so that it can be used for oral administration in various ways.

The process for preparing engineered carbon, as an effective process for preparing the engineered carbon having the above structure, has an advantage in that it can maximize efficiency and yield and can be performed without spatial restrictions.

### BRIEF DESCRIPTION OF THE DRAWINGS

FIG. 1 illustrates a method of measuring the major axis diameter of engineered carbon according to an embodiment.

FIG. 2 is an image showing the outer shape of engineered carbon according to an embodiment.

FIG. 3 schematically illustrates the structure from the surface to the inside of engineered carbon according to an embodiment using a cross-section thereof.

FIG. 4 is a picture showing the appearance of engineered carbon according to an embodiment.

FIG. 5 is an SEM photograph of the surface of engineered carbon that has adsorbed a lipid component according to an embodiment.

### BEST MODE FOR CARRYING OUT THE INVENTION

The present invention provides engineered carbon formed by carbonizing green coffee beans, whole coffee beans, or a combination thereof.

Advantages and features of the present invention and methods for achieving them will become apparent with reference to the following embodiments. However, the present invention is not limited to the embodiments disclosed below, but will be implemented in various different forms. Rather, the embodiments are provided to completely disclose the present invention and to completely inform those of ordinary skill in the art to which the present invention pertains of the scope of the invention. The invention is defined by only the claims.

In order to clearly express various layers and regions in the drawings, the thicknesses are enlarged. In the drawings, for convenience of description, the thicknesses of some layers and regions are exaggerated. The same numerals refer to the same elements throughout the present specification.

As used herein, a singular expression covers a plural expression unless the context clearly dictates otherwise. In this specification, it is to be understood that the terms “comprise,” “have,” and the like indicate the presence of features, numbers, steps, actions, elements, parts, or combinations thereof; and that they do not exclude the presence of the possibilities of addition of one or more of other features, numbers, steps, actions, elements, parts, or combinations thereof.

An embodiment provides engineered carbon formed by carbonizing green coffee beans, whole coffee beans, or a combination thereof. It should be understood that the term “engineered” in “engineered carbon” encompasses physical, chemical, mechanical, thermal treatment, and the like and may encompass an activation process.

The green coffee beans may be dried seeds of coffee cherries, which are fruits of a coffee tree. The drying may be carried out by a natural dry process or a wet dry process.

The whole coffee beans may be obtained by additionally processing the green coffee beans. Specifically, the additional processing may be thermal treatment at 150° C. to 300° C.

The country of origin or production of the coffee cherries does not matter, but the contents of the components constituting the green coffee beans or whole coffee beans may vary depending on the country of origin or production.

It is preferable that the engineered carbon formed by carbonizing the green coffee beans, whole coffee beans, or a combination thereof comprises one or more elements selected from the group consisting of carbon (C), hydrogen (H), oxygen (O), nitrogen (N), sulfur (S), aluminum (Al), calcium (Ca), chromium (Cr), copper (Cu), iron (Fe), potassium (K), magnesium (Mg), manganese (Mn), sodium (Na), phosphorus (P), silicon (Si), titanium (Ti), zinc (Zn), and a combination thereof in a predetermined range to be described below.

According to another embodiment of the present invention, the engineered carbon has an average particle diameter of 0.1 cm to 2.5 cm and comprises a plurality of independent pores, wherein the average size of the independent pores may be 10 μm to 90 μm, and the average thickness of a partition wall spatially separating the independent pores may be 1 nm to less than 1 μm.

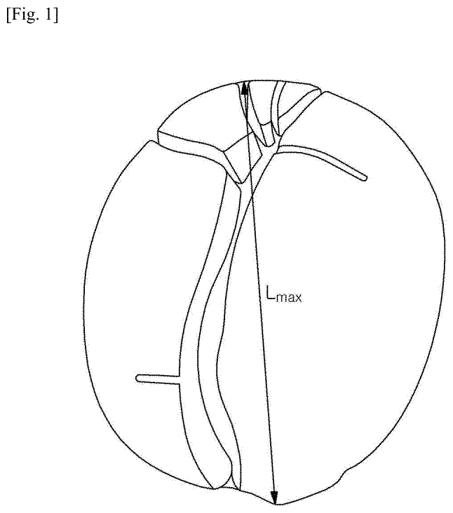

The engineered carbon may be in the form of particles. The average particle diameter of the particles may be about 0.1 cm to about 2.5 cm, for example, about 0.1 cm to about 1.5 cm, for example, from 0.1 cm to about 1 cm. The particle diameter may be defined as a major axis diameter measured on a projection image of one of the engineered carbon particles. Referring to FIG. 1, the major axis diameter refers to the length of the longest straight line (Lₘₐₓ) when two arbitrary points on the outer perimeter of the engineered carbon particle are connected in a straight line on the projection of one of the engineered carbon particles.

As the size of the engineered carbon satisfies the above range, the use of the engineered carbon may be diversified. For example, when the engineered carbon is used for food, it can be distributed in the form of particles having the above particle size to achieve excellent texture. It may be advantageous for being changed in various shapes such as powder.

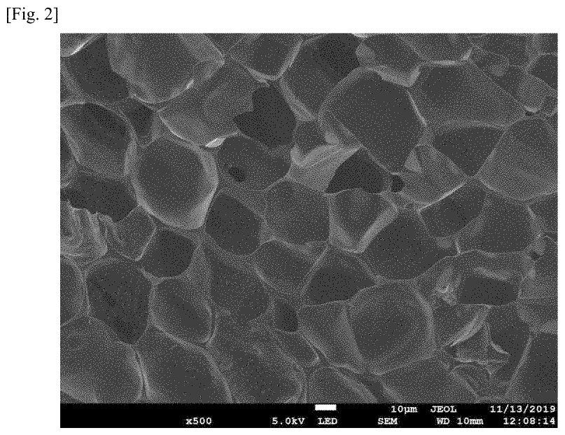

FIG. 2 is a photograph showing the surface of engineered carbon according to an embodiment taken with a scanning electron microscope (SEM). Referring to FIG. 2, the engineered carbon has a porous structure comprising a plurality of independent pores. The “independent pores” refer to pores in which adjacent pores are spatially separated by a sidewall structure in a plurality of pores on the surface of the engineered carbon. Such spatial separation should be understood to encompass not only a case of complete separation, but also a case where a void or the like is formed in some regions of the sidewall, but is recognized as being substantially separated on a projection image such as an SEM photograph.

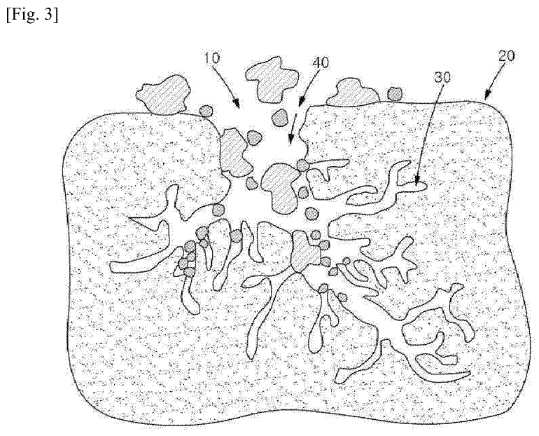

FIG. 3 schematically illustrates the structure from the surface to the inside of engineered carbon according to an embodiment using a cross-section thereof. Referring to FIG. 3, the average pore size of the plurality of independent pores (10) exposed on the surface may be about 10 μm to about 90 μm, for example, about 20 μm to about 70 μm. The “average pore size” refers to a number average value calculated by measuring the major axis diameters of a plurality of pores present per unit area of about 0.03 mm² in an SEM photograph taken on the surface of the engineered carbon. In such an event, the surface of the engineered carbon photographed to derive the average pore size may be arbitrarily selected. If the average pore size in the above range is derived from the surface of 50% by area or more of the total surface of the engineered carbon, it should be understood that the average pore size of the plurality of independent pores of the entire engineered carbon is within the above range. As the average pore size satisfies the above range, the adsorption performance of the engineered carbon may be enhanced. Specifically, the independent pores of the engineered carbon may modify their inner surfaces to have adsorption selectivity for a specific component. If they have an average pore size within the above range, it is possible to secure a sufficient surface area for such modification.

Referring to FIG. 3, the plurality of independent pores (10) may comprise a passage (30) connected to the inside from the surface (20) of the engineered carbon. In an embodiment, the passage (30) may have a structure in which the width thereof is narrowed in a direction from the surface to the inside of the engineered carbon. Thus, the particles to be adsorbed by the engineered carbon may be adsorbed in stages according to their size while they move through the passage (30). The particles to be adsorbed may be sequentially adsorbed in the order of relatively large particles to small particles in a direction from the surface to the inside of the engineered carbon.

In an embodiment, the passage (30) connected to one independent pore (10) may have a structure connected to a passage (30) connected to adjacent another independent pore (10) in some regions. In such a case, although the two adjacent pores are recognized as independent pores spatially separated by a sidewall on the surface of the engineered carbon, they may have a structure connected by a passage in the interior of the engineered carbon.

The engineered carbon may further comprise micropores (40) located in the distal region of the passage (30). The micropore (40) may serve to adsorb particles having a fine size among the particles to be adsorbed. In an embodiment, the micropore (40) may have an average pore size of about 1 nm or more and less than about 10 μm, for example, about 1 nm or more and less than about 8 μm, for example, about 1 nm to about 5 μm.

Referring back to FIG. 2, the plurality of independent pores have a structure in which adjacent pores are separated by a partition wall structure. The partition wall may have an average thickness of about 1 nm or more and less than about 1 μm, for example, about 1 nm to about 900 nm, for example, about 1 nm to about 800 nm. The partition wall serves to spatially separate the plurality of independent pores and, at the same time, secures the supportability of the entire pore structure. As it has a thickness within the above range, it can maintain the porous structure well without collapse of the shape in the course of modifying the surface of the pores or adsorbing a specific component.

In an embodiment, the pores measured by the BJH method (Barrett-Joyner-Halenda method) on the surface of the engineered carbon comprise micropores of 2 nm or less; mesopores greater than 2 nm to 50 nm; and macropores greater than 50 nm. The total volume of the macropores may be greater than the total volume of the micropores.

The total volume ratio (pore volume ratio) of the macropores to the micropores may be 1:0.1 to 0.9, 1:0.1 to 0.8, 1:0.1 to 0.7, 1:0.1 to 0.6, or 1:0.1 to 0.5. If the total volume of the macropores is greater than the total volume of the micropores in the engineered carbon, it is possible to significantly reduce the adsorption amount of nitrogen (N₂), the adsorption amount of carbon dioxide (CO₂), or the adsorption amount of both. That is, nitrogen (N₂) or carbon dioxide (CO₂) is mainly adsorbed in the micropores. Since the engineered carbon according to an embodiment of the present invention has a small total volume of micropores, it is possible to minimize the adsorption of nitrogen (N₂), carbon dioxide (CO₂), or both.

The micropores may have a total volume of 0.3 cm³/g to 0.6 cm³/g. The micropores may have a total volume of 0.3 cm³/g to 0.5 cm³/g. The micropores may have a total volume of 0.3 cm³/g to 0.45 cm³/g.

In an embodiment, the engineered carbon may have a porosity of about 10% by volume to about 90% by volume, for example, about 20% by volume to about 90% by volume, for example, about 30% by volume to about 90% by volume. The porosity of the engineered carbon stands for the percentage of the volume occupied by the plurality of independent pores in the total volume of the engineered carbon. It may be an indicator of the adsorption or absorption capacity of the engineered carbon.

In an embodiment, the engineered carbon may have a density, defined as the ratio of weight to volume, of about 0.1 g/ml to about 0.8 g/ml, for example, about 0.3 g/ml to about 0.8 g/ml.

In an embodiment, the plurality of independent pores of the engineered carbon may comprise a functional group bonded to the surface thereof. The bond between the surface of the engineered carbon and the functional group may be a Van der Waals bond, a covalent bond, an ionic bond, a hydrogen bond, a bond by electrostatic attraction, or a physical bond. The functional group is a functional group that binds to a material to be adsorbed by the engineered carbon. For example, it may comprise one selected from the group consisting of a hydroxyl group, a carboxyl group, an aldehyde group, a carbonyl group, an amino group, a nitro group, and a combination thereof. The bond between the functional group and the material to be adsorbed may be a Van der Waals bond, a covalent bond, an ionic bond, a hydrogen bond, a bond by electrostatic attraction, or a physical bond.

The material to be adsorbed is not limited as long as it is a material capable of binding to the functional group. For example, it may comprise one selected from the group consisting of carbon monoxide (CO), ammonia, acetone (CH₃COCH₃), urethane, phenol, arsenic, formaldehyde (HCHO), acetaldehyde (CH₃CHO), naphtylamine, butane, methanol, pyrene, naphthalene, dimethylnitrosamine, mercury, cadmium, chromium, lead, tar, nicotine, benzopyrene, toluidine, hydrogen cyanide, dibenzacridine, vinyl chloride, dichloro diphenyl trichloroethane (DDT), volatile sulfur compound (VSC), hydrogen sulfide, methyl mercaptan, dimethylsulfide, butylate, propionate, valerate, indole, lactic acid, lipid, phospholipid, glycolipid, fatty acid, steroid, terpenoid, lipoprotein, and a combination thereof.

In an embodiment, the engineered carbon may have an adsorption amount of nitrogen (N₂) of about 2,000 m²/g or less. Specifically, the adsorption amount of nitrogen (N₂) of the engineered carbon may be about 0.1 m²/g to about 2,000 m²/g, for example, about 1.0 m²/g to about 1,500 m²/g.

Specifically, the engineered carbon may have an adsorption amount of nitrogen (N₂), as measured using the Brunauer-Emmett-Teller (BET) equation, of 300 m²/g or less, 200 m²/g or less, 100 m²/g or less, 80 m²/g or less, 50 m²/g or less, 30 m²/g or less, 10 m²/g or less, 8 m²/g or less, 6 m²/g or less, 5 m²/g or less, 4.5 m²/g or less, 4 m²/g or less, 3 m²/g or less, or 2 m²/g or less. In addition, the engineered carbon may have an adsorption amount of nitrogen (N₂) of 0 m²/g or more, 0.0001 m²/g or more, 0.0005 m²/g or more, 0.001 m²/g or more, 0.01 m²/g or more, or 0.1 m²/g or more.

If the adsorption amount of nitrogen (N₂) exceeds the above range, there is a possibility that beneficial substances, as well as harmful substances, to the human body are adsorbed.

The adsorption amount of nitrogen (N₂) of the engineered carbon may be calculated by the BET equation by measuring the nitrogen isothermal adsorption curve at −195.85° C. using a BET specific surface area measuring device.

In an embodiment, the engineered carbon may have an adsorption amount of carbon dioxide (CO₂) of about 2,000 m²/g or less. Specifically, the adsorption amount of carbon dioxide (CO₂) of the engineered carbon may be about 0.1 m²/g to about 2,000 m²/g, for example, about 1.0 m²/g to about 1,500 m²/g.

The adsorption amount of carbon dioxide (CO₂) of the engineered carbon may be calculated by the Dubinin-Radushkevich or Dubinin-Astakhov equation by measuring the carbon dioxide isothermal adsorption curve at 0° C. using a Dubinin-Radushkevich or Dubinin-Astakhov specific surface area measuring device.

According to an embodiment of the present invention, the engineered carbon may have an adsorption amount of carbon dioxide (CO₂), as measured using the Dubinin-Astakhov equation, of 500 m²/g or less.

Specifically, the engineered carbon may have an adsorption amount of carbon dioxide (CO₂), as measured using the Dubinin-Astakhov equation, of 400 m²/g or less, 300 m²/g or less, 280 m²/g or less, 270 m²/g or less, 260 m²/g or less, 250 m²/g or less, 220 m²/g or less, 200 m²/g or less, or 190 m²/g or less. In addition, the adsorption amount of carbon dioxide (CO₂) of the engineered carbon may be 0.1 m²/g or more, 1 m²/g or more, 10 m²/g or more, 20 m²/g or more, 30 m²/g or more, 50 m²/g or more, 80 m²/g or more, 100 m²/g or more, 110 m²/g or more, 120 m²/g or more, 140 m²/g or more, or 150 m²/g or more. The adsorption amount of carbon dioxide (CO₂) of the engineered carbon by the Dubinin-Astakhov equation may be calculated by, for example, vacuum-drying 1 g of the engineered carbon at 150° C., measuring the carbon dioxide isothermal adsorption curve at 0° C. using a specific surface area measuring device (TriStar II 3020 manufactured by Micromeritics), and calculating it using the Dubinin-Astakhov equation.

If the adsorption amount of carbon dioxide (CO₂) exceeds the above range, there is a possibility that beneficial substances, as well as harmful substances, to the human body are adsorbed.

In an embodiment, the engineered carbon may have an adsorption rate (%) of lipid, as defined by the following Equation 1, of about 5% to about 400%, for example, about 10% to about 100%.

Adsorption rate (%) of lipid=(M2−M1)/M1×100 [Equation 1]

In Equation 1, M1 is the weight (g) of the engineered carbon, and M2 is the weight (g) after the engineered carbon is immersed in olive oil for 30 minutes.

According to another embodiment of the present invention, the engineered carbon may have an adsorption amount of lipid of 0.5 ml/g to 5 ml/g. The adsorption amount of lipid of the engineered carbon stands for the volume (ml) of lipid adsorbed per 1 g of the engineered carbon. It may be measured by, for example, charging water and olive oil to a measuring cylinder, adding the engineered carbon thereto, taking it out after 10 minutes, and checking the reduced amount of olive oil.

Specifically, the engineered carbon may have an adsorption amount of lipid of 0.5 ml/g to 4.5 ml/g, 0.6 ml/g to 4.3 ml/g, 0.7 ml/g to 4.2 ml/g, 0.5 ml/g to 2.5 ml/g, 0.7 ml/g to 2.5 ml/g, 2.6 ml/g to 5 ml/g, or 2.6 ml/g to 4.5 ml/g.

If the adsorption amount of lipid satisfies the above range, it is possible to adsorb only harmful substances without adsorbing substances beneficial to the human body; thus, various applications for oral administration are possible.

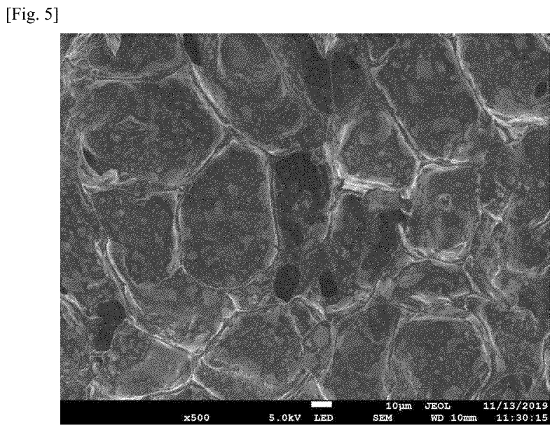

FIG. 5 is an SEM photograph of the surface of engineered carbon that has adsorbed a lipid component as an example.

According to another embodiment the present invention, the ratio (ml/m²) of the adsorption amount (ml/g) of lipid to the adsorption amount (m²/g) of carbon dioxide (CO₂) may be 0.0003 to 0.03, 0.0008 to 0.03, 0.001 to 0.03, 0.001 to 0.025, 0.002 to 0.02, or 0.003 to 0.02.

If the ratio (ml/m²) of the adsorption amount (ml/g) of lipid to the adsorption amount (m²/g) of carbon dioxide (CO₂) satisfies the above range, it is more advantageous for adsorbing only harmful substances without adsorbing substances beneficial to the human body; thus, various applications for oral administration are possible.

If the ratio (ml/m²) of the adsorption amount (ml/g) of lipid to the adsorption amount (m²/g) of carbon dioxide (CO₂) is outside the above range, there is a possibility that beneficial substances, as well as harmful substances, to the human body are adsorbed.

According to an embodiment of the present invention, as the adsorption amount of nitrogen (N₂) or the adsorption amount of carbon dioxide (CO₂) and the adsorption amount of lipid are controlled, the engineered carbon can adsorb only harmful substances without adsorbing substances beneficial to the human body. That is, when the engineered carbon is used for food, the engineered carbon can adsorb harmful substances in the body after ingestion of the engineered carbon and then discharged out of the body; thus, various applications of the engineered carbon for oral administration are possible.

In an embodiment, the engineered carbon may have an adsorption rate (%) of formaldehyde, as defined by the following Equation 2, of about 10% to about 300%, for example, about 10% to about 50%.

Adsorption rate (%) of formaldehyde=(V2−V1)/V1×100 [Equation 2]

In Equation 1, V1 is the weight (g) of the engineered carbon, and V2 is the weight (g) after the engineered carbon is exposed to formaldehyde for 30 minutes.

According to an embodiment of the present invention, the deodorization rate of formaldehyde and acetaldehyde may be 98% or more, respectively.

For example, the deodorization rate of formaldehyde may be 98.5% or more, 99% or more, or 99.2% or more.

In addition, for example, the deodorization rate of acetaldehyde may be 98.5% or more, 98.7% or more, or 98.8% or more.

The engineered carbon may also enhance the deodorization rate of ammonia, benzene, or toluene in addition to the deodorization rate of formaldehyde and acetaldehyde.

For example, the deodorization rate of ammonia may be 95% or more, 95.5% or more, or 96% or more.

For example, the deodorization rate of benzene may be 95% or more, 95.2% or more, or 96% or more.

For example, the deodorization rate of toluene may be 97% or more, 97.5% or more, or 98% or more.

The deodorization rates of ammonia, benzene, formaldehyde, acetaldehyde, and toluene of the engineered carbon of the present invention may be calculated, for example, through a deodorization test using the KS I 2218 standard. The deodorization test may be carried out by measuring the residual concentration of a specific gas using a gas detection tube for a deodorizing performance test and calculating the percentage of reduction relative to the initial concentration.

In an embodiment, the engineered carbon may comprise one selected from the group consisting of carbon, hydrogen, oxygen, nitrogen, sulfur, and a combination thereof. The element components constituting the engineered carbon may be determined by the raw materials of the engineered carbon and the functional group of the engineered carbon for adsorption. In an embodiment, the engineered carbon may comprise carbon, hydrogen, oxygen, and nitrogen. The engineered carbon may comprise carbon in an amount of from about 10% by weight to about 90% by weight, hydrogen in an amount of about 0.1% by weight to about 10% by weight, oxygen in an amount of about 1.0% by weight to about 30% by weight, and nitrogen in an amount of about 0.1% by weight to about 10% by weight. The total content of carbon, hydrogen, oxygen, and nitrogen does not exceed 100% by weight.

The weight ratio of nitrogen to hydrogen among the element components constituting the engineered carbon may be about 1:3 to about 3:1, for example, about 1:2 to about 2:1. As the weight ratio of nitrogen to hydrogen satisfies the above range, the binding performance of the engineered carbon to a predetermined material to be adsorbed may be secured at a desired level. The weight ratio of carbon to oxygen among the element components constituting the engineered carbon may be about 1:3 to about 20:1, for example, about 1:1 to about 20:1, for example, about 1:1 to 15:1. As the weight ratio of carbon to oxygen satisfies the above range, the binding performance of the engineered carbon to a predetermined material to be adsorbed may be secured at a desired level.

For example, the engineered carbon may have a content of carbon of about 50% to about 95% by weight, for example, about 60% to about 95% by weight, for example, about 65% to about 95% by weight.

In an embodiment, the engineered carbon may comprise one or more elements selected from the group consisting of aluminum (Al), calcium (Ca), chromium (Cr), copper (Cu), iron (Fe), potassium (K), magnesium (Mg), manganese (Mn), sodium (Na), phosphorus (P), silicon (Si), titanium (Ti), zinc (Zn), and a combination thereof.

When the engineered carbon comprises aluminum, it may comprise aluminum in an amount of about 1 mg to about 1,000 mg, for example, about 1 mg to about 100 mg, for example, about 500 mg to about 1,000 mg, based on 1 kg of the engineered carbon.

When the engineered carbon comprises calcium, it may comprise calcium in an amount of about 10 mg to about 10,000 mg, for example, about 10 mg to about 400 mg, for example, about 400 mg to about 10,000 mg, based on 1 kg of the engineered carbon.

When the engineered carbon comprises cadmium, cobalt, or chromium, it may comprise cadmium, cobalt, or chromium in an amount of 0 (zero) to about 20 mg, respectively, based on 1 kg of the engineered carbon.

When the engineered carbon comprises copper, it may comprise copper in an amount of about 1 mg to about 200 mg based on 1 kg of the engineered carbon.

When the engineered carbon comprises iron, it may comprise iron in an amount of about 10 mg to about 900 mg based on 1 kg of the engineered carbon.

When the engineered carbon comprises potassium, it may comprise potassium in an amount of about 10 mg to about 100,000 mg, for example, about 10 mg to about 1,000 mg, for example, about 1,000 mg to about 100,000 mg, based on 1 kg of the engineered carbon.

When the engineered carbon comprises magnesium, it may comprise magnesium in an amount of about 100 mg to about 10,000 mg, for example, about 100 mg to about 1,000 mg, for example, about 1,000 mg to about 10,000 mg, based on 1 kg of the engineered carbon.

When the engineered carbon comprises manganese, it may comprise manganese in an amount of about 1 mg to about 300 mg based on 1 kg of the engineered carbon.

When the engineered carbon comprises sodium, it may comprise sodium in an amount of about 10 mg to about 5,000 mg, for example, about 10 mg to about 1,000 mg, for example, about 1,000 mg to about 5,000 mg, based on 1 kg of the engineered carbon.

When the engineered carbon comprises phosphorus, it may comprise phosphorus in an amount of about 10 mg to about 10,000 mg based on 1 kg of the engineered carbon.

When the engineered carbon comprises silicon, it may comprise silicon in an amount of about 10 mg to about 3,000 mg based on 1 kg of the engineered carbon.

When the engineered carbon comprises titanium, it may comprise titanium in an amount of 0 (zero) to about 500 mg based on 1 kg of the engineered carbon.

When the engineered carbon comprises zinc, it may comprise zinc in an amount of 0 (zero) to about 300 mg based on 1 kg of the engineered carbon.

In an embodiment, the engineered carbon may comprise calcium and magnesium. In such a case, the weight ratio of calcium and magnesium contained in the engineered carbon may be about 1:1 to about 1:5, for example, about 1:1.1 to about 1:3.5.

In an embodiment, the engineered carbon comprises calcium and magnesium, the engineered carbon comprises calcium and magnesium in an amount of greater than 0 (zero) to about 1,000 mg, respectively, based on 1 kg of the engineered carbon, and the weight ratio of calcium and magnesium contained in the engineered carbon may be about 1:1 to about 1:5, for example, about 1:1.1 to about 1:3.5.

Calcium is an essential nutrient that prevents osteoporosis, prevents blood acidification, and plays a role in neurotransmission. Calcium accounts for the largest amount of minerals in the body, but it is also easy to be deficient. Calcium deficiency may cause excessive contractions or cramps in the muscles of the hands, feet, and face. Magnesium is required for more than 300 enzyme reactions, and it regulates the pumping function of the heart and dilates the coronary arteries, preventing angina pectoris and heart attack. Magnesium regulates the entry of calcium ions into the cells to prevent the constriction of blood vessels and weakens the strong contraction of cardiac muscle cells to lower blood pressure. There are many routes for calcium intake in a general diet, but there are not so many routes for magnesium intake, because most magnesium is removed during the refining process of grains or the processing of engineered foods. Magnesium is consumed when people are stressed, and modern people with a lot of stress need sufficient magnesium intake. In addition, calcium and magnesium each affect the absorption rate of each other, and it is important to maintain an appropriate ratio thereof.

The engineered carbon may comprise calcium in an abundant amount of about 3,500 mg to about 5,000 mg and magnesium in an abundant amount of about 5,000 mg to about 10,000 mg, based on 1 kg of the engineered carbon. The high content of magnesium in the engineered carbon means that the drying and carbonization steps of the green coffee beans, whole coffee beans, or a combination thereof is non-destructive.

A typical carbonization step uses a rotary kiln. In the carbonization step in a rotary kiln, raw materials such as green coffee beans and whole coffee beans are transferred through the rotation of an impeller in a chamber having a horizontal cylindrical structure, and external hot air is supplied during the transfer to carbonize the raw materials being transferred inside the chamber. In the carbonization step in a rotary kiln, thermal energy and physical frictional energy are supplied at the same time, which may cause significant damage to the raw materials.

In the engineered carbon prepared by the preparation process of an embodiment to be described below, calcium or magnesium are abundant without a loss thereof, so that it may be used, for example, as a health supplement. An appropriate ratio of calcium to magnesium may be in a range of about 1:1 to about 1:2.

In another embodiment, the engineered carbon comprises calcium and magnesium, and the content of magnesium may be greater than the content of calcium in the engineered carbon. In general, calcium and magnesium coexist in the body. Calcium is the most abundant mineral in the body, and there are various routes for intake thereof. In contrast, magnesium lacks routes for intake thereof, and excessive accumulation of calcium in a magnesium-deficient state may cause problems such as kidney stones. Accordingly, a health supplement containing a large amount of magnesium relative to calcium, such as the engineered carbon according to an embodiment, may have an advantage in securing an ideal ratio of calcium to magnesium in the human body and ensuring the balance of all nutrients.

For example, it comprises calcium and magnesium in an amount of greater than about 1,000 mg to about 10,000 mg, respectively, based on 1 kg of the engineered carbon, and the weight ratio of calcium and magnesium contained in the engineered carbon may be about 1:1 to about 1:5, for example, about 1:1.1 to about 1:3.5, for example, about 1:1.1 to about 1:3, for example, 1:1 to 1:2.

In an embodiment, the engineered carbon may comprise sodium and potassium. In such a case, the weight ratio of sodium and potassium contained in the engineered carbon may be about 1:0.01 to about 1:3,000, for example, about 1:0.01 to about 1:1,500, for example, about 1:300 to about 1:1,500, for example, about 1:0.01 to 1:10.

In an embodiment, the engineered carbon comprises sodium and potassium, and the content of sodium may be greater than the content of potassium in the engineered carbon. For example, the weight ratio of sodium and potassium contained in the engineered carbon may be about 1:0.01 to less than about 1:1.

In another embodiment, the engineered carbon comprises sodium and potassium, and the content of potassium may be the same as, or greater than, the content of sodium in the engineered carbon. For example, the weight ratio of sodium and potassium contained in the engineered carbon may be about 1:1 to about 1:10, for example, greater than about 1:1 to about 1:3,000.

In another embodiment, the engineered carbon comprises sodium and potassium, and the content of potassium may be greater than the content of sodium in the engineered carbon. For example, the weight ratio of sodium and potassium contained in the engineered carbon may be about 1:300 to about 1:10,000, for example, greater than about 1:500 to about 1:5,000.

Potassium is a nutrient known to maintain normal blood pressure, dispose of waste products in the body, participate in energy metabolism, and activate brain functions. An increase in potassium intake may improve blood pressure and lower the risks of cardiovascular diseases. Although it is important to properly maintain a balance between potassium and sodium in the body, the corresponding potassium intake is insufficient due to the increase in sodium intake caused by excessive consumption of engineered foods in modern times. An intake of abundant potassium instead of a decrease in sodium intake may be nutritionally beneficial in many ways, including lowering blood pressure.

In an embodiment, the engineered carbon may comprise manganese and phosphorus. In such a case, the weight ratio of manganese and phosphorus contained in the engineered carbon may be about 1:1 to about 1:500, for example, about 1:50 to about 1:300, for example, about 1:20 to about 1:220, for example, about 1:1 to about 1:30.

As each content and the mutual content ratio of the components such as aluminum, calcium, chromium, copper, iron, potassium, magnesium, manganese, sodium, phosphorus, silicon, titanium, and zinc are adjusted, performance suitable for a predetermined purpose can be selectively implemented. At the same time, it is possible to prevent a deficiency in nutrients essential for the management of chronic diseases such as cancer, cardiovascular diseases, and diabetes and to control the balance of intake thereof.

The engineered carbon according to an embodiment is edible. Activated carbon that has been commonly used is generally prepared from coconut shell, sawdust, wood such as oak or pine, coconut shell or bamboo, and coke, pitch, resin, and the like obtained from coal or petroleum. Impurities remain according to the type of raw materials, making it unsuitable for consumption. In addition, the nutrients that control the components and functions of the body cannot be made directly by the human body, but are absorbed into the human body through food absorbed from the soil; thus, selection of an appropriate raw material is essential.

Referring to FIG. 3, in an embodiment, the engineered carbon has a porous structure comprising a plurality of independent pores comprising a passage (30) connected to the inside from the surface (20). At the same time, inorganic nutrients such as aluminum, calcium, chromium, copper, iron, potassium, magnesium, manganese, sodium, phosphorus, and zinc are distributed not only on the outer surface of the engineered carbon but also on the surfaces of the inner pores.

The engineered carbon contains essential nutrients in the appropriate contents and ratios described above using green coffee beans, whole coffee beans, or a combination thereof. It can implement excellent adsorption performance through the plurality of independent pores; thus, it can be used as a health supplement for, for example, oral administration.

In an embodiment, the engineered carbon may have a total amount of lead, mercury, cadmium, and arsenic of less than about 1,000 ppm, for example, less than about 500 ppm, for example, less than about 300 ppm, for example, about 0 (zero) to about 300 ppm, for example, about 0 to 10 ppm. The engineered carbon is formed from green coffee beans, whole coffee beans, or a combination thereof, and the contents of metal components such as lead, mercury, cadmium, and arsenic can be minimized as compared with engineered carbon prepared from other conventional natural or synthetic materials. As each content and the mutual content ratio of the metal components such as lead, mercury, cadmium, and arsenic are adjusted, it is possible to enhance the adsorption performance for a predetermined adsorption target material or to increase the selectivity for a specific adsorption target material relative to other adsorption target materials. The content of such a metal component may be measured using equipment such as an atomic absorption spectrometer (AAS) or an inductively coupled plasma atomic emission spectrometer (ICPAES).

According to another embodiment, the engineered carbon may have a content of heavy metals in the engineered carbon of less than 20 ppm, less than 15 ppm, less than 10 ppm, less than 9 ppm, less than 8 ppm, less than 6 ppm, less than 5 ppm, less than 4 ppm, or less than 3 ppm, or it may not substantially contain them.

If the content of heavy metals in the engineered carbon is 20 ppm or more, it may be harmful to the human body, so that it may be unsuitable for food, or the utilization of the engineered carbon may be impaired.

The heavy metal in the engineered carbon may comprise at least one selected from the group consisting of lead (Pb), nickel (Ni), chromium (Cr), zinc (Zn), copper (Cu), and cadmium (Cd). The engineered carbon may control the contents of, for example, lead (Pb) and nickel (Ni).

The content of the heavy metal components may be measured using an inductively coupled plasma atomic emission spectrometer (ICPAES).

The heavy metal may comprise lead (Pb) and nickel (Ni) in a total amount of 10 ppm or less, 8 ppm or less, 6 ppm or less, 5 ppm or less, 4 ppm or less, or 3 ppm or less, or it may not substantially comprise the same.

Specifically, the content of lead (Pb) in the engineered carbon may be 3 ppm or less, 2 ppm or less, 1.5 ppm or less, or it may not be substantially contained.

Specifically, the content of nickel (Ni) in the engineered carbon may be 5 ppm or less, 4 ppm or less, 2 ppm or less, 1.5 ppm or less, or it may not be substantially contained.

The engineered carbon may be formed by carbonizing the coffee, thereby minimizing the content of heavy metals in the engineered carbon.

In addition, if the content of heavy metals, in particular, the content of lead (Pb) and nickel (Ni) in the engineered carbon is controlled to the above range, it is harmless to the human body and edible, so that its utility can be further broadened.

According to an embodiment of the present invention, the content of heavy metals in the engineered carbon may be controlled to the specific range because the engineered carbon has specific pore characteristics.

The engineered carbon according to an embodiment of the present invention may have an adsorption amount of nitrogen (N₂) of 300 m²/g or less as measured using the Brunauer-Emmett-Teller (BET) equation and a content of heavy metals therein of less than 20 ppm.

According to an embodiment of the present invention, if the adsorption amount of nitrogen (N₂) and the content of heavy metals in the engineered carbon are controlled, it may be more advantageous for use as food. In particular, the engineered carbon may adsorb only harmful substances without adsorbing substances beneficial to the human body. That is, when the engineered carbon is used for food, the engineered carbon can adsorb harmful substances in the body after ingestion of the engineered carbon and then discharged out of the body; thus, various applications of the engineered carbon for oral administration are possible.

In addition, according to an embodiment of the present invention, the type of coffee or controlling the contents of the components constituting green coffee beans or whole coffee beans may also be an important factor in controlling the adsorption amount of the engineered carbon for specific components and the content of heavy metals in the engineered carbon.

The coffee varieties may include, for example, at least one selected from Arabica species, Robusta species, and Liberica species. The adsorption amount for specific components and the content of heavy metals of the engineered carbon may vary with the varieties.

Specifically, in order to control the adsorption amount for specific components of the engineered carbon and the content of heavy metals in the engineered carbon desired in an embodiment of the present invention, Arabica species, Robusta species, or Liberica species may be used, respectively.

In addition, Arabica species and Robusta species, Robusta species and Liberica species, Arabica species and Liberica species, or Arabica species, Robusta species, and Liberica species may be used as mixed.

For example, when Arabica species and Robusta species are used as mixed, their mixing weight ratio may be 1:9 to 9:1, 2:8 to 8:2, 3:7 to 7:3, or 4:6 to 6:4. Specifically, green coffee beans, whole coffee beans, or a combination thereof in which Arabica species and Robusta species are mixed at the above mixing weight ratio may be carbonized to form the engineered carbon.

When Robusta species and Liberica species are used as mixed, their mixing weight ratio may be 1:9 to 9:1, 2:8 to 8:2, 3:7 to 7:3, or 4:6 to 6:4. Specifically, green coffee beans, whole coffee beans, or a combination thereof in which Robusta species and Liberica species are mixed at the above mixing weight ratio may be carbonized to form the engineered carbon.

When Arabica species and Liberica species are used as mixed, their mixing weight ratio may be 1:9 to 9:1, 2:8 to 8:2, 3:7 to 7:3, or 4:6 to 6:4. Specifically, green coffee beans, whole coffee beans, or a combination thereof in which Arabica species and Liberica species are mixed at the above mixing weight ratio may be carbonized to form the engineered carbon.

If the mixing weight ratio of Arabica species and Robusta species, Robusta species and Liberica species, Arabica species and Liberica species is satisfied, the pore structure of the engineered carbon as described above can be easily achieved. Thus, it is possible to have adsorption selectivity for a specific component and to effectively control the content of heavy metals in the engineered carbon.

Meanwhile, when green coffee beans and whole coffee beans are used as mixed, their mixing weight ratio may be 1:9 to 9:1, 2:8 to 8:2, 3:7 to 7:3, or 4:6 to 6:4.

In addition, the green coffee beans may further comprise defective beans. The defective beans may mean defective coffee beans. The defective beans may be defined according to the defective beans classification standard provided by SCAA (Specialty Coffee Association of America). The defective beans may be contained in an amount of 5% by weight or less, 4% by weight or less, 3% by weight or less, 2% by weight or less, or 1% by weight or less, based on the total weight of the green coffee beans. According to an embodiment of the present invention, even if the green coffee beans comprise defective beans, it is possible to readily achieve the pore structure of the engineered carbon as described above, to have adsorption selectivity for a specific component, and to effectively control the content of heavy metals.

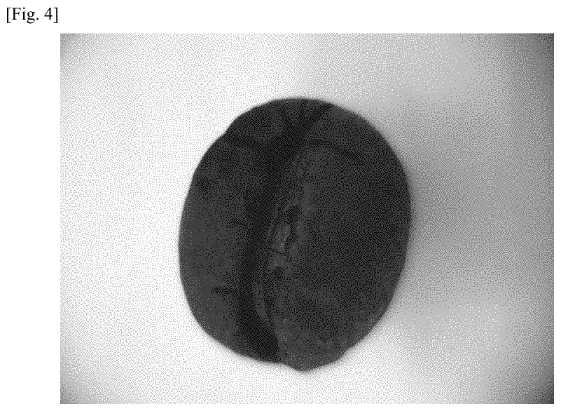

FIG. 4 is a picture showing the appearance of engineered carbon according to an embodiment. Referring to FIG. 4, the engineered carbon may have an outer shape like a green coffee bean or a whole coffee bean. In an embodiment, the engineered carbon may be an engineered product derived from green coffee beans, whole coffee beans, or a combination thereof. The engineered carbon may be a carbon material in which green coffee beans, whole coffee beans, or a combination thereof are processed while the shape of the raw material is maintained. Such a shape can be achieved by suitable raw materials and processing conditions. In the conventional way of manufacturing carbon materials from natural materials, wood or the like is usually used as a raw material; thus, the shape upon final manufacture has a surface generally representing the texture of wood or is in the form of powder or particles. In addition, even if green coffee beans or whole coffee beans are used as raw materials, it is common to manufacture them in the form of powder or particles, which are reprocessed into a desired shape such as pellets. In contrast, the engineered carbon according to an embodiment is a carbonized engineered product in which the shape of green coffee beans or whole coffee beans as a raw material is maintained as suitable raw materials, and processing conditions are comprehensively designed.

Meanwhile, in another embodiment of the present invention, there is provided a process for preparing engineered carbon, which comprises drying green coffee beans, whole coffee beans, or a combination thereof; and thermally treating the dried green coffee beans, whole coffee beans, or a combination thereof.

It is possible to prepare the engineered carbon as described above by the process for preparing an engineered carbon, which has an average particle diameter of 0.1 cm to 2.5 cm and comprises a plurality of independent pores, wherein the average size of the independent pores is 10 μm to 90 μm, and the average thickness of a partition wall spatially separating the independent pores is from 1 nm to less than 1 μm.

The step of drying green coffee beans, whole coffee beans, or a combination thereof may be carried out at about 100° C. to about 400° C., for example, about 100° C. to about 300° C., for example, about 100° C. to about 200° C.

In another embodiment, the step of drying green coffee beans, whole coffee beans, or a combination thereof may be carried out at about 80° C. to about 400° C., for example, about 100° C. to about 300° C., for example, about 100° C. to about 200° C.

The drying step may be carried out within a range of about 30 minutes to about 100 minutes, for example, about 30 minutes to about 90 minutes, based on 1 kg of green coffee beans, whole coffee beans, or a combination thereof.

The moisture content of the green coffee beans or whole coffee beans may be reduced, through the drying, to less than about 5% by weight, for example, less than about 3% by weight, for example, less than about 2% by weight.

In an embodiment, it is preferable that the moisture content of the green coffee beans, whole coffee beans, or a combination thereof is reduced, through the drying step, to greater than 0.1% by weight to less than 10% by weight. If the green coffee beans, whole coffee beans, or a combination thereof is dried to have a moisture content of less than 0.1% by weight, excessive energy is supplied in the drying step, causing an increase in manufacturing costs. And there is a problem in that the moisture content in the green coffee beans or whole coffee beans is too low, so that their processability is poor, and the engineered carbon is thus easily crushed even with a slight impact during the distribution process. On the other hand, if the green coffee beans, whole coffee beans, or a combination thereof is dried to have a moisture content of greater than 10% by weight, the moisture content in the green coffee beans or whole coffee beans is excessively high, so that entanglement or aggregation may take place during carbonization, thereby deteriorating the adsorption characteristics of the engineered carbon.

In an embodiment, the thermal treatment step may be a single thermal treatment step or a multi-stage thermal treatment step. The temperature condition of the thermal treatment may be from about 400° C. to about 1,000° C., for example, from about 400° C. to about 800° C. When the thermal treatment step is a multi-stage thermal treatment step, the multi-stage thermal treatment may be carried out in temperature atmospheres different from each other in the above temperature range. The shape and pore structure of the engineered carbon finally prepared may vary with the design of the thermal treatment temperature range.

The thermal treatment of the dried green coffee beans, whole coffee beans, or a combination thereof may be carried out in an atmosphere of a gas containing one selected from the group consisting of nitrogen (N₂), argon (Ar), oxygen (O₂), hydrogen (H₂), and a combination thereof.

Specifically, the thermal treatment may be carried out in a nitrogen (N₂) atmosphere, an oxygen (O₂) atmosphere, or an atmosphere in which a nitrogen (N₂) atmosphere and an oxygen (O₂) atmosphere are sequentially applied. In an embodiment, when a nitrogen (N₂) atmosphere and an oxygen (O₂) atmosphere are sequentially applied, the nitrogen (N₂) atmosphere may be preceded or the oxygen (O₂) atmosphere may be preceded. The term “in an atmosphere” refers to an atmosphere in which the gas is contained in an amount greater than 50% by weight. As an example, if nitrogen (N₂) gas is contained in an amount of greater than 50% by weight, and other types of gas than nitrogen (N₂) are contained in an amount of less than 50% by weight, it may be understood that the thermal treatment is carried out in a nitrogen (N₂) atmosphere. As another example, if oxygen (O₂) gas is contained in an amount of greater than 50% by weight, and other types of gas than oxygen (O₂) are contained in an amount of less than 50% by weight, it may be understood that the thermal treatment is carried out in an oxygen (O₂) atmosphere.

In an embodiment, the dried green coffee beans, whole coffee beans, or a combination thereof may be thermally treated in a mixed atmosphere. The mixed atmosphere may be an inert atmosphere and an oxygen (O₂) atmosphere or an inert atmosphere and a hydrogen (H₂) atmosphere, in which the inert atmosphere refers to a nitrogen (N₂) and/or argon (Ar) atmosphere. The mixed atmosphere refers to a nitrogen or argon atmosphere containing about 0.1% to about 10% of hydrogen. The hydrogen content in nitrogen or argon may be based on any one of % by mole, % by weight, or % by volume.

The shape and pore structure of the engineered carbon finally prepared, the types and contents of functional groups bonded to the surface, and the types and contents of elements constituting the engineered carbon may vary with the design of the thermal treatment temperature range.

The thermal treatment may be carried out by a microwave irradiation method. Specifically, the thermal treatment may be carried out in a chamber in which a microwave is irradiated, and the internal temperature of the chamber may be set within the thermal treatment temperature range as described above. As thermal treatment using a microwave is adopted, the quality can be improved by enhancing the efficiency as compared with a thermal treatment technology using other equipment such as a conventional rotary kiln. And since the temperature inside the chamber can be accurately monitored in real time, unnecessary overheating can be minimized. In addition, the technology using a conventional rotary kiln has a lot of space restrictions due to the horizontal structure of the rotary kiln, whereas the thermal treatment method according to an embodiment occupies a relatively small space, resulting in an advantage of high space utilization.

The process for preparing an engineered carbon may further comprise modifying the surface of the green coffee beans, whole coffee beans, or a combination thereof. The surface modification step is a step of introducing a functional group for binding a material to be adsorbed to the surface of the green coffee beans, whole coffee beans, or a combination thereof. It may be carried out simultaneously with the thermal treatment step or as a separate step.

In an embodiment, the surface modification step may be carried out under conditions of mixing an acidic material or a basic material with the green coffee beans, whole coffee beans, or a combination thereof, and then injecting a gaseous catalyst composed of air, steam, inert gas, carbon dioxide, or a combination thereof.

Meanwhile, in a carbonization step commonly adopted for preparing engineered carbon, organic materials are thermally decomposed by indirect heating by an external heating source in an anoxic state or in a low-oxygen atmosphere (oxygen concentration of 2 to 4%) to fix carbon to the final product. A typical carbonization step uses a rotary kiln. In the carbonization step in a rotary kiln, raw materials are transferred through the rotation of an impeller in a chamber having a horizontal cylindrical structure, and external hot air is supplied during the transfer to carbonize the raw materials being transferred inside the chamber.

However, in the carbonization step by a conventional rotary kiln, some of the raw material powder is accumulated at the lower part of the chamber during the process of transferring the raw material through the impeller, resulting in a phenomenon of absorbing and blocking some of the heat supplied from the outside into the chamber. As a result, it may cause a decrease in the carbonization rate of the raw material. In addition, in the carbonization technology using a conventional rotary kiln, the temperature can be monitored only at the inlet and outlet of the chamber with a horizontal cylindrical structure, but the temperature inside the chamber cannot be accurately monitored. Thus, unnecessary overheating frequently takes place, which causes a problem in that the yield of a carbonized product is not constant depending on the level of skill of the operators.

Further, in the hot-air carbonization technology using a conventional rotary kiln, if the carbonization step at a high temperature of, for example, 900° C. or higher is repeated, there is a problem in that the internal parts of the carbonization apparatus are damaged, or cracks take place in the junctions between the internal parts, so that harmful gases formed during the carbonization step may unintentionally leak to the outside, thereby impairing the safety of operators.

In the process for preparing engineered carbon according to an embodiment, a specially designed carbonization apparatus may be adopted. The carbonization apparatus may have a cylindrical shape or a hexahedral box shape, but it is not limited thereto. The carbonization apparatus may further comprise a control unit for controlling the internal temperature, a setting unit for setting the temperature conditions and thermal treatment time, and a display unit for monitoring the internal temperature. The carbonization apparatus may further comprise a gas injection unit for injecting gas and a discharge unit for discharging gas formed therein. The number of the gas injection units may be adjusted according to a selection of a nitrogen (N₂) atmosphere, an oxygen (O₂) atmosphere, or a mixed atmosphere in the thermal treatment step. In such a case, there is an advantage in that damage to the raw material in the carbonization step can be minimized as compared with the case where a rotary kiln is adopted.

The thermal treatment atmosphere may be carried out in a carbonization chamber of a specially designed carbonization apparatus. The carbonization apparatus may have a cylindrical shape or a hexahedral box shape, but it is not limited thereto. The carbonization apparatus may further comprise a control unit for controlling the internal temperature, a setting unit for setting the temperature conditions and thermal treatment time, and a display unit for confirming the internal temperature. The carbonization apparatus may further comprise a gas injection unit for injecting gas and a discharge unit for discharging gas formed therein. The number of the gas injection units may be adjusted according to a selection of a nitrogen (N₂) atmosphere, an oxygen (O₂) atmosphere, or a mixed atmosphere in the thermal treatment step.

The engineered carbon according to an embodiment has an advantage in that it may have a structure that can be easily modified to have adsorption selectivity for a specific component, which is attributable to its appropriate pore structure; and that, upon modification, it can achieve excellent adsorption performance for a specific component and, at the same time, can be used for various applications in its overall size and shape. In addition, the process for preparing engineered carbon, as an effective process for preparing the engineered carbon having the above structure, has an advantage in that it can maximize efficiency and yield and can be performed without spatial restrictions.

The engineered carbon may be advantageously used in engineered food by virtue of the above characteristics. Accordingly, in another embodiment of the present invention, there is provided engineered food, which comprises the engineered carbon.

### Mode for Carrying Out the Invention

Hereinafter, the present invention will be described in detail with reference to examples. The following examples are only illustrative of the present invention, and the scope of the present invention is not limited thereto.

### EXAMPLE 1

1 kg of green coffee beans in which Arabica and Robusta species had been mixed in an amount of 50% by weight, respectively, was dried at 100° C. for 3 hours to sufficiently remove moisture present in the green coffee beans.

The moisture content of the raw material measured after drying using a moisture meter (MB45 of OHAUS) was 3% by weight. Next, the dried raw material was put into the carbonization chamber of a carbonization apparatus and thermally treated at 650° C. for 1 hour in a nitrogen (N₂) atmosphere to prepare engineered carbon. Here, the yield of the engineered carbon thus obtained was 4%.

### EXAMPLE 2

Engineered carbon was prepared in the same manner as in Example 1 in which 1 kg of green coffee beans in which Arabica and Robusta species had been mixed in an amount of 50% by weight, respectively, was used as a raw material.

### EXAMPLE 3

Engineered carbon was prepared in the same manner as in Example 1, except that 1 kg of green coffee beans containing about 1% by weight of defective beans was used as a raw material.

### EXAMPLE 4

Engineered carbon was prepared in the same manner as in Example 1, except that 1 kg of green coffee beans in which green coffee beans and whole coffee beans had been mixed at a ratio of about 1:1 was used as a raw material.

### COMPARATIVE EXAMPLE 1

Engineered carbon was prepared in the same manner as in Example 1, except that 1 kg of hardwood was used as a raw material.

### COMPARATIVE EXAMPLE 2

Engineered carbon was prepared in the same manner as in Example 1, except that 1 kg of coconut shell was used as a raw material.

Test Example

Test Example 1: Analysis of the Contents of Inorganic Components

The engineered carbon prepared was analyzed for the contents of inorganic components in the engineered carbon using ICP-MS (inductively coupled plasma mass, Agilent 7900) equipment. The results are shown in Table 1.

TABLE 1

| | | Ex. | Ex. | Ex. | Ex. | C. | C. |
|---|---|---|---|---|---|---|---|
| (Unit: mg/kg) | | 1 | 2 | 3 | 4 | Ex. 1 | Ex. 2 |
| Com- | Al | 21 | 43 | 10 | 10 | 1,080 | 1,020 |
| ponent | Ca | 3,743 | 4,408 | 4,490 | 4,460 | 810 | 420 |
| | Cr | ND | 1 | 1 | 1 | 26 | 24 |
| | Cu | 45 | 50 | 50 | 48 | 4 | 8 |
| | Fe | 153 | 148 | 116 | 158 | 1560 | 310 |
| | K | 72,941 | 84,519 | 93,480 | 92,669 | 1,010 | 200 |
| | Mg | 5,600 | 6,271 | 8,946 | 8,138 | 254 | 163 |
| | Mn | 48 | 56 | 143 | 153 | 103 | 15 |
| | Na | 68 | 89 | 27 | 20 | 390 | 67 |
| | P | 6,943 | 8,229 | 7,951 | 6,859 | 2,7547 | 197 |
| | Si | 60 | 108 | 90 | 70 | 670 | 3,539 |
| | Ti | ND | 3 | 1 | 2 | 73 | 84 |
| | Zn | 20 | 36 | 20 | 20 | 37 | 990 |
| Com- | Ca:Mg | 1:1.50 | 1:1.42 | 1:1.99 | 1:1.82 | 1:0.31 | 1:0.39 |
| ponent | Na:K | 1:1072.7 | 1:949.7 | 1:3462.2 | 1:4633.5 | 1:2.6 | 1:3.0 |
| ratio | Mn:P | 1:144.6 | 1:146.9 | 1:55.6 | 1:44.8 | 1:267.4 | 1:13.1 |

ND = Not detected

Referring to Table 1, the engineered carbon of the Examples was rich in calcium, magnesium, and potassium as compared with the engineered carbon of the Comparative Examples. Thus, it has an advantage in securing nutrients.

Test Example 2: Measurement of the Content of Heavy Metals

The contents of lead (Pb) and nickel (Ni) in the engineered carbon prepared in the Examples and Comparative Examples were each measured.

The contents of lead (Pb) and nickel (Ni) were measured by an inductively coupled plasma atomic emission spectrometer (ICP-AES). The results are shown in Table 2 below.

Test Example 3: Measurement of Deodorization Rate

In order to determine the deodorizing effect of the engineered carbon of the present invention for ammonia, benzene, formaldehyde, acetaldehyde, and toluene, the deodorization rate was measured under the following conditions by the deodorization performance test gas detection tube method. The results are shown in Table 2 below.
Gas bag: 5 liters (gas volume in the gas bag: 3 liters)
Sample amount: 30 g
Measurement time: after 2 hours
Initial concentration:
1) ammonia—100 ppm
2) formaldehyde—15 ppm
3) acetaldehyde—14 ppm
4) benzene—20 ppm
5) toluene—20 ppm

Deodorization rate (%)=((Cb−Cs)/Cb)×100
Cb: blank, the concentration of tested gas remaining in the test gas bag after 2 hours
Cs: Sample of the examples, the concentration of tested gas remaining in test gas bag after 2 hours

TABLE 2

| | | | | | | C. | C. |
|---|---|---|---|---|---|---|---|
| | | Ex. | Ex. | Ex. | Ex. | Ex. | Ex. |
| | | 1 | 2 | 3 | 4 | 1 | 2 |
| Content | Pb | — | — | — | — | 4 | 11 |
| of heavy | Ni | — | — | — | — | 16 | 10 |
| metals (ppm) | | | | | | | |
| Deodorization | Ammonia | 96.0 | 95.6 | 96.1 | 96.4 | 98.1 | 97.9 |
| rate (%) | Benzene | 96.3 | 95.8 | 96.5 | 95.2 | 97.2 | 98.5 |
| | Formaldehyde | 99.3 | 99.5 | 99.2 | 99.6 | 99.5 | 99.4 |
| | Acetaldehyde | 98.5 | 98.7 | 99.0 | 98.7 | 99.1 | 98.4 |
| | Toluene | 97.5 | 97.6 | 97.9 | 98.1 | 97.4 | 97.3 |

As can be seen from Table 2, heavy metals such as lead (Pb) and nickel (Ni) were not measured in the engineered carbon of Examples 1 to 4. The deodorization rates for ammonia, benzene, formaldehyde, acetaldehyde, and toluene were 95% or more, confirming that they were overall excellent.

In contrast, while the deodorization rates of the engineered carbon of Comparative Examples 1 and 2 were similar to those of Examples 1 to 4, the content of lead (Pb) was 4 ppm and 11 ppm, respectively, and the content of nickel (Ni) was 16 ppm and 10 ppm, respectively, which was significantly increased.

It can be seen from the above results that the engineered carbon according to an embodiment of the present invention is edible and harmless to the human body.

Test Example 4: Measurement of Adsorption Amount

(1) Measurement of Adsorption Amount of Nitrogen

1 g of the engineered carbon was dried under vacuum at 150° C., and the amount of nitrogen gas adsorbed in a liquid nitrogen atmosphere (−195.85° C.) was measured using a specific surface area measurement device (TriStar II 3020 manufactured by Micromeritics). The specific surface area (m²/g) was calculated using the Brunauer-Emmett-Teller (BET) equation.

TABLE 3

| | Ex. | Ex. | Ex. | Ex. | C. | C. |
|---|---|---|---|---|---|---|
| | 1 | 2 | 3 | 4 | Ex. 1 | Ex. 2 |
| Adsorption amount of | 1.4 | 3.2 | 4.5 | 2.7 | 1,431 | 1,390 |
| nitrogen (N₂) (m²/g) | | | | | | |

As can be seen from Table 3, the engineered carbon of Examples 1 to 4 had an adsorption amount of nitrogen (N₂) of 300 m²/g or less, which was significantly reduced as compared with Comparative Examples 1 and 2.

Specifically, the engineered carbon of Examples 1 to 4 had an adsorption amount of nitrogen (N₂) of 1.4 m²/g to 4.5 m²/g, whereas the engineered carbon of Comparative Examples 1 and 2 had an adsorption amount of nitrogen (N₂) of 1,431 m²/g and 1,390 m²/g, respectively, which was greater than those of the engineered carbon of Examples 1 to 4 by 250 times or more.

Since the total volume of micropores (cm³/g) of Examples 1 to 4 was smaller than the total volume of macropores, the adsorption amount of nitrogen (N₂) could be controlled within the above range. In such a case, the engineered carbon is expected to be more advantageous in adsorbing only harmful substances without adsorbing substances beneficial to the human body.

(2) Measurement of Adsorption Amount of Carbon Dioxide

1 g of the engineered carbon was dried under vacuum at 150° C., and the carbon dioxide isothermal adsorption curve was measured at 0° C. using a specific surface area measuring device (TriStar II 3020 manufactured by Micromeritics). The Dubinin-Astakhov equation was used for calculation.

(3) Measurement of Adsorption Amount of Lipid

The volume of lipid adsorbed by 1 g of the engineered carbon was measured by charging 40 ml of water and 10 ml of olive oil to a measuring cylinder, adding 2 g of the engineered carbon thereto, taking it out after 10 minutes, and checking the reduced amount of olive oil.

TABLE 4

| | | Ex. | Ex. | Ex. | Ex. | | C. |
|---|---|---|---|---|---|---|---|
| | | 1 | 2 | 3 | 4 | C. Ex. 1 | Ex. 2 |
| Adsorption | CO₂ (m²/g) | 278 | 189 | 218 | 257 | 1407 | 773 |
| amount | Lipid | 1.0 | 0.7 | 2.6 | 4.2 | (Not | 0.2 |
| | (ml/g) | | | | | measurable) | |

As can be seen from Table 4, the engineered carbon of Examples 1 to 4 had an adsorption amount of carbon dioxide (CO₂) of 500 m²/g or less and an adsorption amount of lipid satisfying the range of 0.5 ml/g to 5 ml/g.

Specifically, the engineered carbon of Examples 1 to 4 had an adsorption amount of carbon dioxide (CO₂) of 189 m²/g to 278 m²/g, whereas the engineered carbon of Comparative Examples 1 and 2 had an adsorption amount of carbon dioxide (CO₂) of 773 m²/g or 1,407 m²/g, which fell outside of the range according to an embodiment of the present invention.

Meanwhile, the engineered carbon of Examples 1 to 4 had an adsorption amount of lipid of 0.7 ml/g to 4.2 ml/g, whereas the engineered carbon of Comparative Examples 1 and 2 had an adsorption amount of lipid of 0.2 ml/g, or it was not measurable, thereby falling outside of the range according to an embodiment of the present invention.

Since the total volume of macropores (cm³/g) of Examples 1 to 4 was larger than the total volume of micropores, the adsorption amounts of carbon dioxide (CO₂) and lipid could be selectively controlled. In such a case, the engineered carbon is expected to be more advantageous in adsorbing only harmful substances without adsorbing substances beneficial to the human body.

The engineered carbon according to an embodiment of the present invention has an advantage in that it may have a structure that can be easily modified to have adsorption selectivity for a specific component, which is attributable to its appropriate pore structure; and that, upon modification, it can achieve excellent adsorption performance for a specific component and, at the same time, can be used for various applications in its overall size and shape.

In addition, the engineered carbon has an advantage in that it is harmless to the human body, contains essential nutrients necessary for humans such as calcium, magnesium, potassium, sodium, phosphorus, and manganese, and can achieve excellent adsorption performance as engineered carbon, so that it can be used for oral administration in various ways.

The process for preparing engineered carbon, as an effective process for preparing the engineered carbon having the structure, has an advantage in that it can maximize efficiency and yield and can be performed without spatial restrictions.

### REFERENCE NUMERALS OF THE DRAWINGS

10: independent pores

20: surface of engineered carbon

30: passage

40: micropore

1. Engineered carbon formed by carbonizing green coffee beans, whole coffee beans, or a combination thereof.

2. The engineered carbon of claim 1, wherein the engineered carbon has an average particle diameter of 0.1 cm to 2.5 cm and comprises a plurality of independent pores, the average size of the independent pores is 10 μm to 90 μm, and the average thickness of a partition wall spatially separating the independent pores is 1 nm to less than 1 μm.

3. The engineered carbon of claim 2, wherein the pores measured by the BJH method (Barrett-Joyner-Halenda method) on the surface of the engineered carbon comprise micropores of 2 nm or less; mesopores greater than 2 nm to 50 nm; and macropores greater than 50 nm, and the micropores have a total volume of 0.3 cm³/g to 0.6 cm³/g.

4. The engineered carbon of claim 1, wherein the engineered carbon comprises one or more elements selected from the group consisting of aluminum (Al), calcium (Ca), chromium (Cr), copper (Cu), iron (Fe), potassium (K), magnesium (Mg), manganese (Mn), sodium (Na), phosphorus (P), silicon (Si), titanium (Ti), zinc (Zn), and a combination thereof.

5. The engineered carbon of claim 4, wherein the engineered carbon comprises magnesium (Mg) and calcium (Ca), and the content of magnesium is greater than the content of calcium.

6. The engineered carbon of claim 1, wherein the engineered carbon has an adsorption amount of nitrogen (N₂) of 300 m²/g or less as measured using the Brunauer-Emmett-Teller (BET) equation and a content of heavy metals therein of less than 20 ppm.

7. The engineered carbon of claim 6, wherein the heavy metals comprise lead (Pb) and nickel (Ni), and the total content thereof is 10 ppm or less.

8. The engineered carbon of claim 1, wherein the engineered carbon has an adsorption amount of carbon dioxide (CO₂) of 500 m²/g or less as measured using the Dubinin-Astakhov equation and an adsorption amount of lipid of 0.5 ml/g to 5 ml/g.

9. The engineered carbon of claim 8, wherein the ratio (ml/m²) of the adsorption amount (ml/g) of lipid to the adsorption amount (m²/g) of carbon dioxide (CO₂) is 0.0003 to 0.03.

10. The engineered carbon of claim 1, wherein the engineered carbon has an outer shape of a green coffee bean or a whole coffee bean and has a deodorization rate for formaldehyde and acetaldehyde of 98% or more, respectively.

11. A process for preparing engineered carbon, which comprises drying green coffee beans, whole coffee beans, or a combination thereof; and thermally treating the dried green coffee beans, whole coffee beans, or a combination thereof.

12. Engineered food, which comprises the engineered carbon of claim 1.
